(19) United States
(12) Patent Application Publication
(10) Pub. No.: US 2009/0055248 A1
(43) Pub. Date: Feb. 26, 2009

(54) METHOD OF ADMINISTERING A SEARCH ENGINE WITH A MARKETING COMPONENT

(76) Inventor: Andrew L. Wolf, Bloomingdale, IL (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/257,569

(22) Filed: Oct. 24, 2008

Related U.S. Application Data
(63) Continuation-in-part of application No. 11/507,745, filed on Aug. 22, 2006.

(51) Int. Cl. G06Q 30/00; G06Q 50/00

(52) U.S. Cl. 705/10; 705/14

(57) ABSTRACT

A computer system capable of administering a search engine program with a marketing component, which includes at least one client device operatively connected to a host server through a communication network to communicate data between the client device and the host server. The marketing component includes free or discounted access to an application program that provides various services in exchange for the user's agreement to use the search engine program as a primary search engine. The search engine is free of advertisements, except for paid placement listings.

### CROSS-REFERENCE TO RELATED APPLICATIONS

This application is a continuation-in-part of U.S. patent application Ser. No. 11/507,745 filed Aug. 22, 2006 from which priority is claimed, and is hereby incorporated by reference.

### STATEMENT REGARDING FEDERALLY SPONSORED RESEARCH

Not Applicable.

### BACKGROUND OF THE INVENTION

In recent years, many businesses have begun providing goods and services to consumers through the Internet. However, a number of these businesses have struggled with finding a successful revenue model to support their consumer offerings.

Many websites have had success using various methods of advertising to increase revenues. For example, many search engines use paid placement listings, paid inclusions, and banner ads. Generally, paid placement listings, sometimes referred to as “cost-per-click”, are where merchants pay for a high ranking or listing in the results of a search, when there is a “match” for a keyword on which the search is based that is somehow associated with the merchant. Paid inclusion is when a website owner pays a fee in order to have his web pages included in a listing, but with a higher ranking than it would otherwise have in the listing. Banner ads are simply conventional ads posted on the search engine web page and are often keyword-linked.

In contrast, other types of subscription based businesses, such as information providers (e.g. newspapers, magazines, financial publishers) and networking services (e.g. Classmates.com, Reunion.com) have generally experienced restricted growth in the number of their users on account of requiring subscription fees from users. Typically, requiring subscription fees reduce the number of users that frequently visit the website. In turn, advertising methods, such as banner ads, are less lucrative for subscription based websites due to the smaller audience size.

Therefore, there is a long felt need for a method and apparatus that allows businesses to provide an array of free or discounted services which might otherwise require a subscription. The present invention discloses a method of administering a search engine with a marketing component for this purpose.

### DESCRIPTION OF THE DRAWINGS

In the accompanying drawings which form part of the specification:

FIG. 1 is a block diagram of a system for administrating a search engine with a marketing component in accordance with the present invention;

FIG. 2 is a sample search engine webpage appearing on the display of the client device;

FIG. 3 is a sample search engine webpage appearing on the display of the client device and displaying search results;

FIG. 4 is a sample homepage appearing on the display of the client device;

FIG. 5 is a sample registration form appearing on the display of the client device;

FIG. 6 is sample instruction webpage appearing on the display of the client device;

FIG. 7 is a sample download webpage appearing on the display of the client device;

FIG. 8 is an alternate embodiment of a system for administrating a search engine with a marketing component in accordance with the present invention;

FIG. 9 is another alternate embodiment of a system for administering a search engine with a marketing component in accordance with the present invention;

FIG. 10 is yet another alternate embodiment of a system for administrating a search engine with a marketing component in accordance with the present invention;

FIG. 11 is a further alternate embodiment of a system for administrating a search engine with a marketing component in accordance with the present invention;

FIG. 12 is a sample search engine webpage appearing on the display of the client device and displaying search results.

Corresponding reference numerals indicate corresponding parts throughout the several figures of the drawings.

### DETAILED DESCRIPTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention. Additionally, it is to be understood that the invention is not limited in its application to the details of construction and the arrangements of components set forth in the following description or illustrated in the drawings. The invention is capable of other embodiments and of being practiced or carried out in various ways. Also, it is to be understood that the phraseology and terminology used herein is for the purpose of description and should not be regarded as limiting.

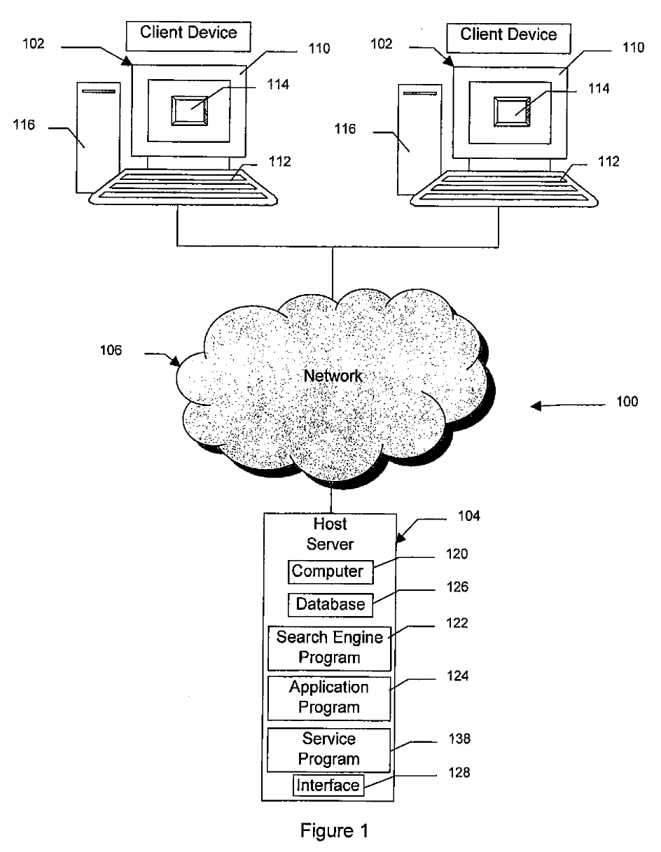

As shown in FIG. 1, an embodiment of the present invention, generally referred to as a computer system 100, includes at least one client device 102 operatively connected to at least one host server 104 through a communication network 106 to communicate data between the client device 102 and the host server 104. The computer system 100 is capable of administering a search engine program 122 with a marketing component, which is described below in further detail. In the preferred embodiment, the marketing component includes free or discounted access to an application program 124 that provides various services, such as a service program 138, in exchange for the user's agreement to use the search engine program 122 as their primary search engine.

In the embodiment of FIG. 1, the client device 102 is a computer 108, including a processor, memory, a mass storage device, a display device 110, and an input device 112, such as a keyboard, that is capable of running a network interfacing program 114, such as web browser software available, for example, from Netscape® Corporation, Apple® Corporation, or from Microsoft® Corporation. The client device 102 is appropriately equipped with a network interfacing device 116 for communicating data with the network 106, such as a dial-up modem, a cable modem, a satellite connection, a DSL (Digital Subscriber Line) connection, a LAN (Local Area Network), or the like. Alternate embodiments of client device 102 include any electrical or electronic device capable of communicating with the server 104 through the network 106, such as, for example, a personal digital assistant (PDA), cellular phone, a telephone operating with an interactive voice-system, or a television operating with a cable or satellite television interactive system.

A user interacts with the client device 102 by viewing data via the display 110 and entering data via the keyboard 112, or other suitable input interface such as a mouse, microphone, touch screen, and the like. The network interfacing program 114 allows the user to enter addresses of specific web pages to be retrieved, which are referred to as Uniform Resource Locators, or URLs. The web pages can contain various types of content from plain textual information to more complex multimedia and interactive content, such as software programs, graphics, audio signals, videos, and so forth. A set of interconnected web pages, usually including a homepage, are managed on a server device as a collection collectively referred to as a website. The content and operation of such websites are managed by the server device, such as host server 104, which is operatively connected to the network 106.

In the embodiment of FIG. 1, the network 106 is the Internet, which uses a suitable communications protocol, such as HyperText Transfer Protocol (HTTP), to communicate data between the client devices 102 and the host server 104. However, the network 106 can be any network that allows an exchange of data between the client devices 102 and the host server 104, such as a LAN or WAN (Wide Area Network). In addition, any suitable type of communications protocol can be used, such as FTP (File Transfer Protocol), SNMP (Simple Network Management Protocol), TELNET (Telephone Network), and the like.

The host server 104 preferably comprises a computer system 120, having a processor, memory, and a mass storage device, which is capable of running a search engine program 122 and the application program 124. A database 126 is stored on the mass storage device. Also, the host server 104 is appropriately equipped with a network interfacing device 128 for communicating data with the network 106, such as a dial-up modem, a cable modem, a satellite connection, a DSL connection, a LAN, or the like. If necessary to accommodate large amounts of information or run numerous applications, alternate embodiments of the host server 104 can comprise multiple computer systems, multiple databases, or any combination thereof.

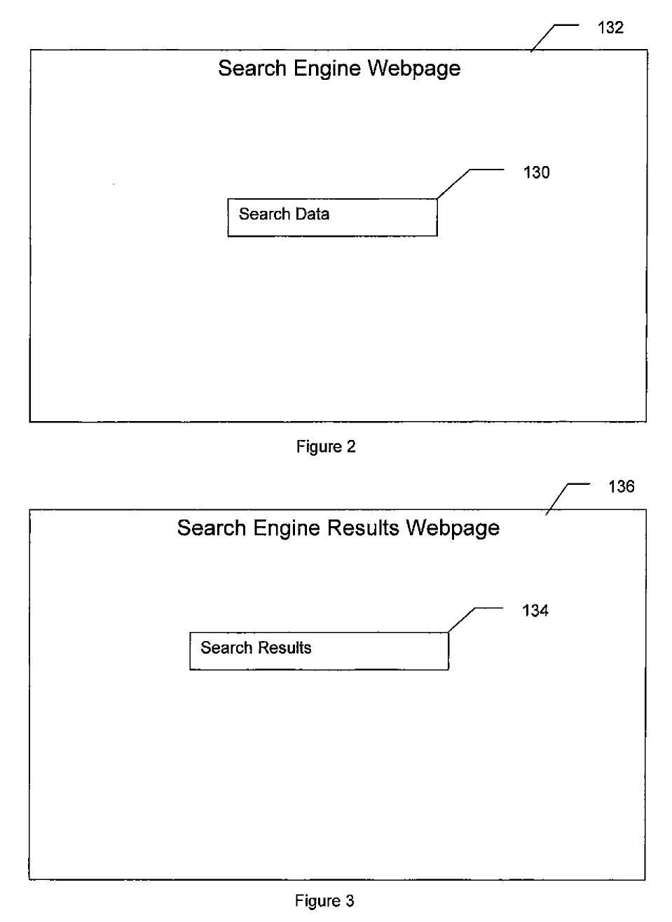

The search engine program 122 allows users through the interfacing program 114 of the client device 102 to submit queries to identify web pages of interest on the Internet by entering search data 130, such as keywords, into a web page 132 as shown in FIG. 2. Based on the search data 130, the search engine program 122 generates search results 134 from an index of search records on the database 126. The search results 134 include, at least in part, a list of hypertext links to web pages that contain relevant information to the search data 130. The host server 104 transmits the search results 134, in the form of a web page 136 as shown in FIG. 3, to the client device 102, where it is displayed on the display 110. Those skilled in the art will recognize that any typical search engine program, such as Google™, Yahoo!®, MSN®, Ask.com™, and the like, can be used.

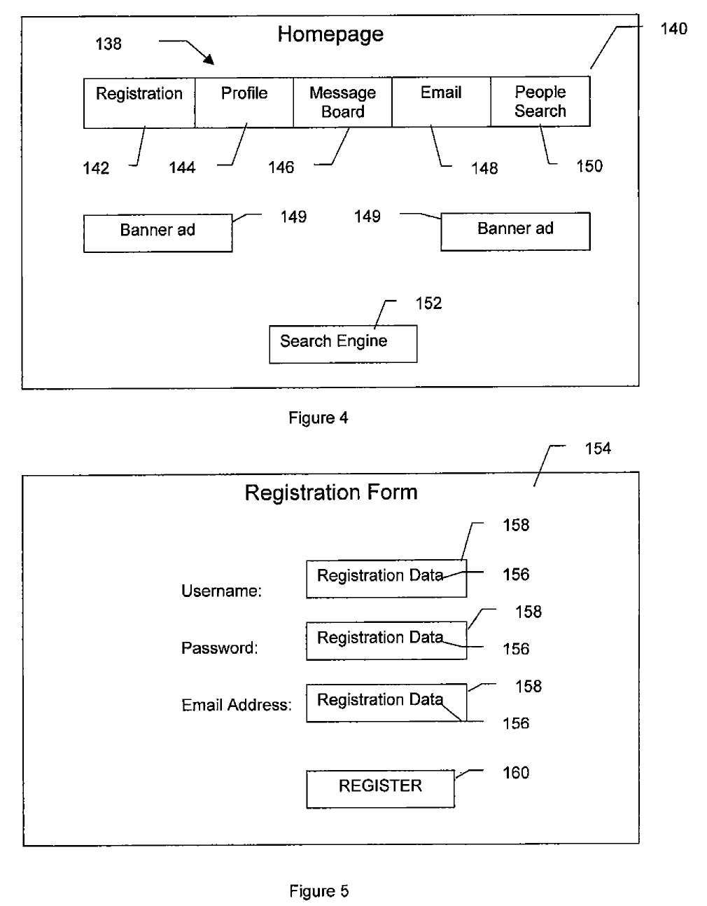

The application program 124 allows users through the interfacing program 114 of the client device 102 to access various service programs 138 on the host server 104. As shown in FIGS. 1 and 4, the application program 124 generates a web page, such as home page 140, that transmits through the network 106 and displays on the client device display 110 via the interfacing program 114. In the preferred embodiment, the home page 140 includes a menu of the various service programs 138 including Registration 142, Enter/Update Profile 144, Message Board 146, Email 148, and People Search 150. The menu also provides a link 152 to the search engine program 122. The user interacts with the application program 124 by entering data with the input device 112, in this case by selecting one of the service programs 138. By selecting one of these options, the application program 124 generates additional web pages and interacts with the database 126 and the client device 102 in order to provide the selected service programs 138 to the user.

The service programs 138 shown in FIG. 4 are exemplary only and not inclusive. Those skilled in the art will recognize the application program 124 can provide access to any number of service programs 138, which may include, but are not limited to discussion forums, newsgroups, networking services, bulletin boards, chat room, retail and commercial sales, auctions, weblogs, email, video logging, Massively Multiplayer Online Game (MMOG), database searches, and other web applications. In addition, the application program 124 can be limited to a single service program or provide multiple service programs.

The host server 104 can display advertisements, such as banner ads 149 (FIG. 4), to the participant on the display 110 of the client device 102. The operator of the host server 104 can display banner ads 149 for varoius merchants in exchange for an appropriate compensation, such as a monetary fee. Those skilled in the art will recognize that any type of advertisements can be displayed to participants, including but not limited to pop-up, hyperlinks, sponsership, rich media, or interstitial advertisments. In addition, the advertisements can be dispalyed on any of the various webpages displayed by the host server 104.

As previously mentioned, the host server 104 will only provide the user with free access to the service programs 138 provided by the application program 124 if the user agrees to utilize the search engine program 122 as their primary search engine. The host server 104 can also provide access to the service programs 138 for a fee if the user does not agree to use the search engine 122 as a primary search engine. To utilize the search engine 122 as a primary search engine, the user must satisfy a designated set of criteria, which includes registering as a participant, installing a tracking program on the client device, and using the search engine program 122 to perform a designated percentage of all user searches over a specified period of time.

The operation of the system 100 begins with the step of registering users as participants. To register, a user utilizes the client device 102 to access the home page 140 and select Registration 142, which displays the web page registration form 154 shown in FIG. 5 to the user on the display 110 of the client device 102. Using the keyboard 112, the user enters registration data 156 into the fields 158 of the registration form 154, which can include, but is not limited to a Username, a Password, an Email address, and other personal contact information. After entering the registration data 156, the user presses the “Register” button 160 to electronically transfer the registration data 156 through the network 106 to the host server 104. The registration data 156 is recorded in a master account on the database 126, so that the host server can identify the user as a participant.

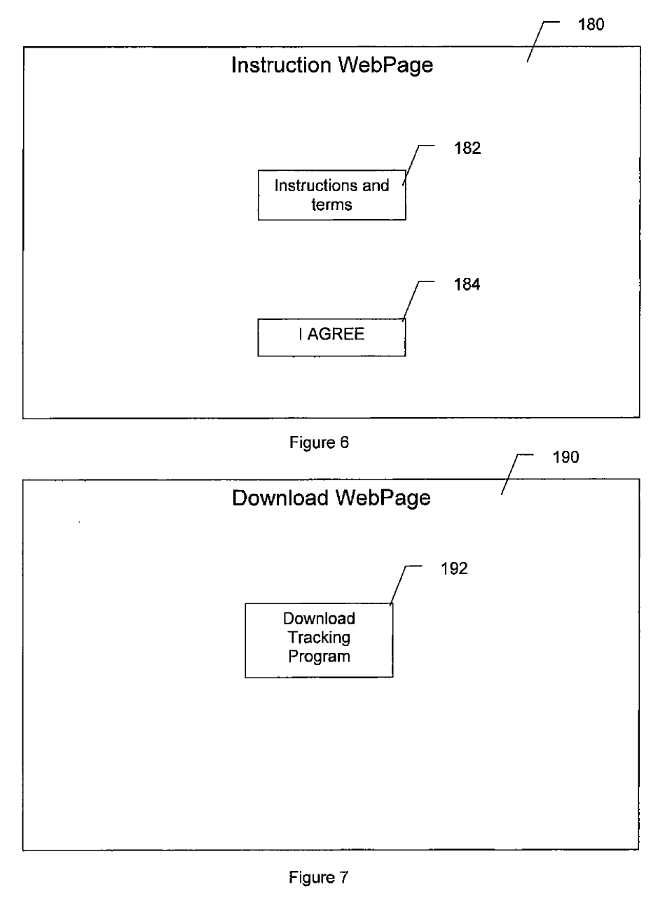

Subsequently, the host server 104 displays an instruction webpage 180 to the participant on the display 110 of the client device 102 with instructions and the terms 182 of the marketing plan (FIG. 6). The host server 104 can also display to the participant on the display 110 a requirement that the registrant affirm by pressing an “I Agree” button 184 or similar confirmation button that he or she agrees to the expressed terms.

To confirm registration of the participant, the host server 104 sends an electronic message through the network 106 to the appropriate client device 102 using the stored email address. The message includes all of the registration data 156 of the registrants master account stored on the database 126 so that the registrant can review the registration data 156 for any errors.

After completing registration, the participant is prompted on a download webpage 190 to download and install a tracking program 192 from the database 126 of the host server 104 to the client device 102 (FIG. 7). The tracking program 192 monitors the searches performed by the registrant and determines the percentage of searches that are performed with the search engine program 122 on the host server 104 as compared to other search engine programs on other servers. The tracking program 192 periodically transmits tracking data to the host server 104 for recording in the master account of the database 126. In a preferred embodiment, the tracking program 192 monitors the searches performed by the registrant over a predetermined time period, such as a week. If the registrant uses the search engine program 122 to perform a number of searches equal to or greater than the designated percentage, preferably 50% or higher, then the host server 104 continues to provide to the user access to the application program 124. If the registrant uses the search engine program 122 to perform a number of searches less than the designated percentage, the host server 104 will discontinue the user's access to the application program 124.

Those skilled in the art will recognize that any appropriate time period can be used by the tracking program 192 to monitor the use of the search engine program 122. In addition, the designated percentage can be any percentage deemed appropriate by the operator of the host server 104. Also, alternate embodiments can include a notice to the user that the search engine program 122 is not being used as the primary search engine, along with a grace period to let the user rectify the percentage of use before discontinuing access to the application program 124.

Once the registration and installation of the tracking program 192 is complete, the user is provided with access to the service programs 138 by the application program 124. Each time the user accesses the homepage 140 of the host server 104 through the client device 102, the application program 124 confirms that the user is a registered participant. This can be done by a manual or automatic login procedure, which requires the user to provide the username and password associated with their master account.

The computer system 100 and methods of operation described above can be modified without departing from the scope of the invention. In one alternate embodiment, the user is not provided with access to all of the service programs 138 by the application program 124 upon registration, but rather is required to select from one or more of the service programs 138. In this embodiment, the user can earn access to additional service programs 138 through various methods. For example, the participant can earn access to there additional service programs 138 by referring additional users to register with the host server 104, or by maintaining the search engine program 122 as the user's primary search engine for a designated duration of time (i.e. six months). Those skilled in the art will recognize that other methods of earning access to service programs 138 can also be used. For example, the participant can earn access to additional service programs 138 by using the primary search engine for a higher designated percentage of searches, such as 10% higher than the original designated percentage.

In another alternate embodiment, the user need only use the search engine program 122 a designated number of times over a designated time period, rather than a percentage of searches. For example, the host server 104 could require that the user perform a minimum of fifty (50) searches using the search engine program 122 every week or month. In this example, the user is free to use other search engines as often as he wants, as long as he uses the search engine program 122 the minimum number of times for the designated time period.

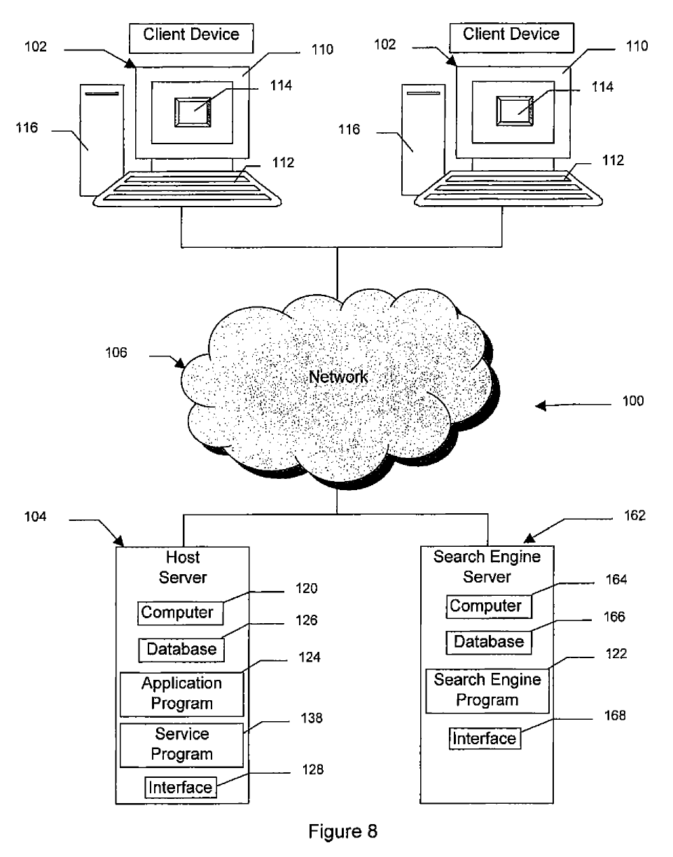

FIG. 8 illustrates another embodiment in which the search engine program 122 is operated from a search engine server 162, which is separate from the host server 104. In this arrangement, the user accesses the search engine program 122 through the homepage 140 of the host server 104, but operation of the search engine program is carried out on the search engine server 162. In this way, the host server 104 effectively acts as a communication relay between the client device 102 and the search engine server 122.

The search engine server 162 preferably comprises a computer system 164, having a processor, memory, and a mass storage device, which is capable of running the search engine program 122. A database 166 is stored on the mass storage device. Also, the search engine server 162 is appropriately equipped with a network interfacing device 168 for communicating data with the network 106, such as a dial-up modem, a cable modem, a satellite connection, a DSL connection, a LAN, or the like. If necessary to accommodate large amounts of information or run numerous applications, alternate embodiments of the search engine server 162 can comprise multiple computer systems, multiple databases, or any combination thereof.

The search engine program 122 allows users through the interfacing program 114 of the client device 102 to submit queries to identify web pages of interest on the Internet by entering search data 130, such as keywords, into a web page 132 as shown in FIG. 2. The host server 104 transmits the search data 130 to the search engine server 162. Based on the search data 130, the search engine program 122 generates search results 134 from an index of search records on the database 126, which are transmitted to the host server 104. The search results 134 include, at least in part, a list of hypertext links to web pages that contain relevant information to the search data 130. The host server 104 transmits the search results 134, in the form of a web page 136 as shown in FIG. 3, to the client device 102, where it is displayed on the display 110. Those skilled in the art will recognize that any typical search engine program, such as Google™, Yahoo!®, MSN®, Ask.com™, and the like, can be used.

In another alternate embodiment, the search engine web page 136 can be replaced with a search engine toolbar that is incorporated into the network interfacing program 114.

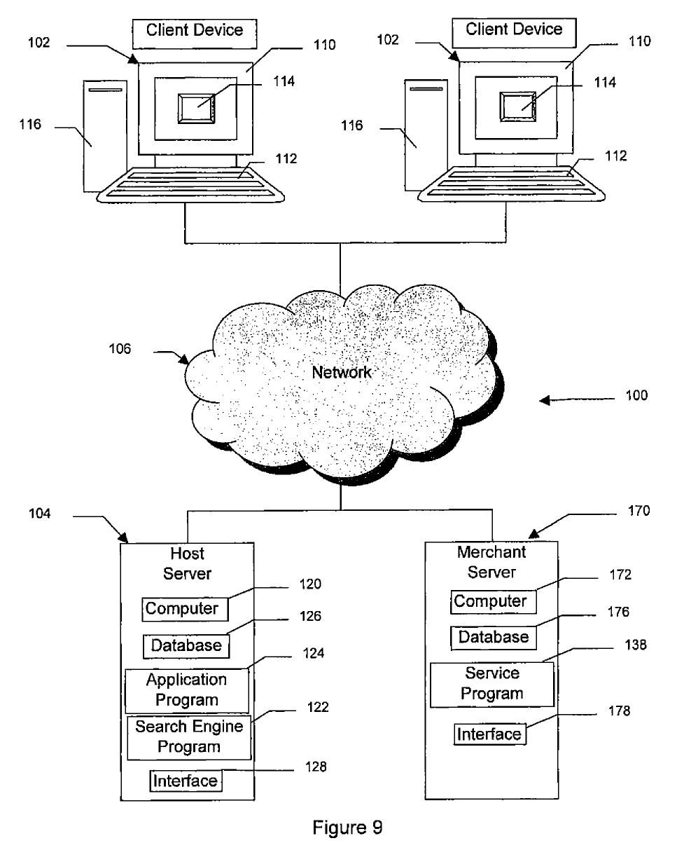

FIG. 9 illustrates another embodiment in which the application program 124 provides free or discounted access to service programs 138 available at a merchant server 170, which is separate from the host server 104.

The merchant server 170 preferably comprises a computer system 172, having a processor, memory, and a mass storage device, which is capable of running the service program 138. A database 176 is stored on the mass storage device. Also, the merchant server 170 is appropriately equipped with a network interfacing device 178 for communicating data with the network 106, such as a dial-up modem, a cable modem, a satellite connection, a DSL connection, a LAN, or the like. If necessary to accommodate large amounts of information or run numerous applications, alternate embodiments of the merchant server 170 can comprise multiple computer systems, multiple databases, or any combination thereof.

The host server 104 allows users through the interfacing program 114 of the client device 102 to access the service program 138 of the merchant server 170. The service program 138 can provide any type of service, such as discussion forums, newsgroups, networking services, bulletin boards, chat room, retail and commercial sales, auctions, weblogs, email, video logging, Massively Multiplayer Online Game (MMOG), database searches, and other web applications. For the purposes of this specification, the term merchant is used in its broadest sense, including but not limited to any third-party business person or entity engaged in the sale of good and/or services.

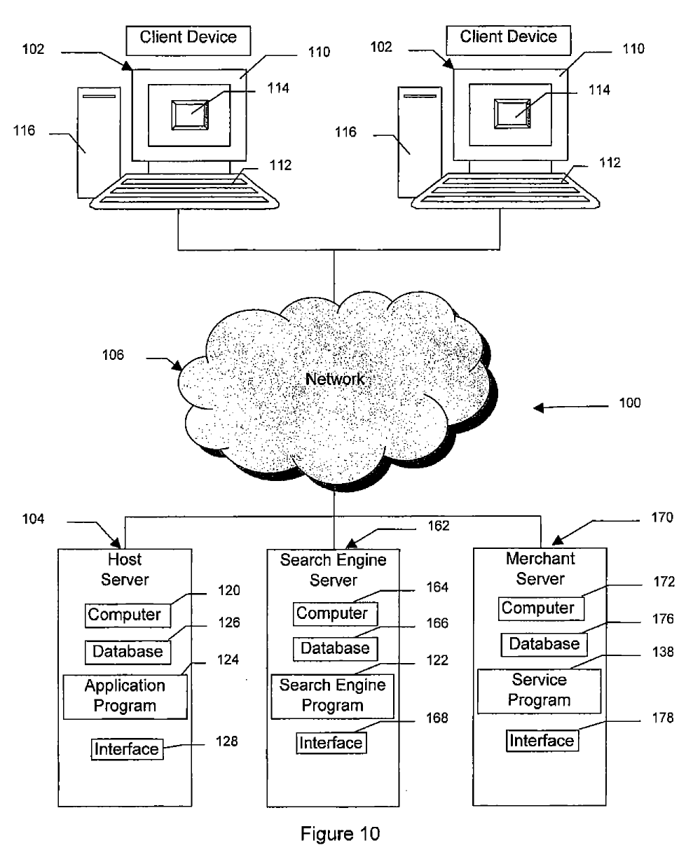

FIG. 10 illustrates another embodiment in which the search engine program 122 is operated from a search engine server 162, which is separate from the host server 104, and the application program 124 provides free or discounted access to service programs 138 available at a merchant server 170, which is also separate from the host server 104. The search engine server 162 and merchant server 170 operate as previously described above.

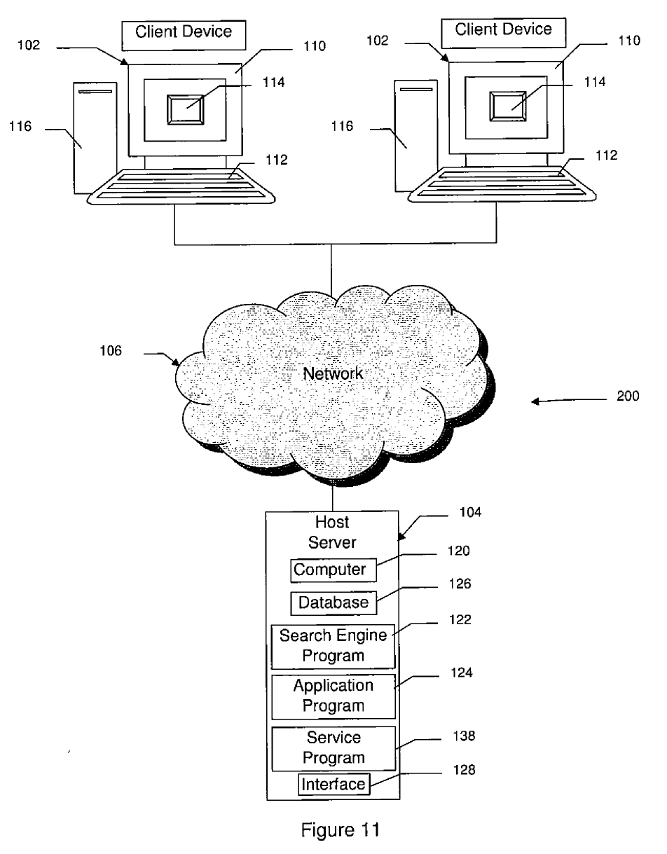

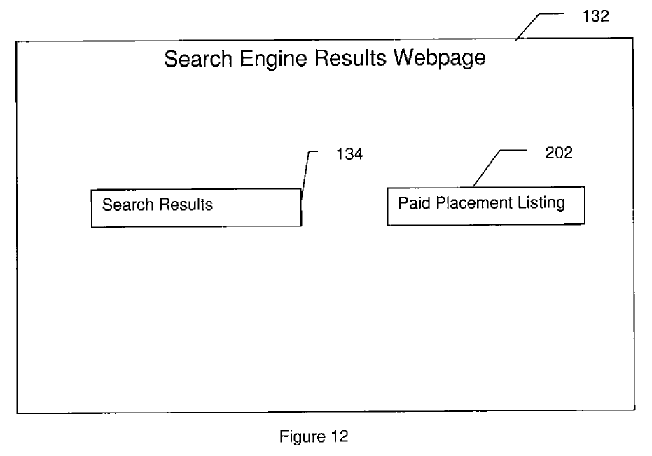

Another alternate embodiment of a computer system 200 is shown in FIG. 11-12. For ease of understanding, components common between the various embodiments are identified with matching reference numbers. As with the preferred embodiment, the marketing component includes free or discounted access to an application program 124 that provides various services, such as a service program 138, in exchange for the user's agreement to use the search engine program 122 as their primary search engine. Similarly, the host server 104 will only provide the user with free access to the service programs 138 provided by the application program 124 if the user agrees to utilize the search engine program 122 as their primary search engine. To utilize the search engine 122 as a primary search engine, the user must satisfy a designated set of criteria, which includes registering as a participant, installing a tracking program on the client device, and using the search engine program 122 to perform a designated percentage of all user searches over a specified period of time.

However, in this alternate embodiment the user is provided with free access to the service programs 138 without requiring a subscription fee or transmitting to the client device 102 any advertisements, including, but not limited to banner ads, pop-up ads, video ads, audio ads, data mining software, Spam, email solicitation, and the like. Rather, the search engine program 122 will utilize paid search listings, including, but not limited to paid placement listings or paid inclusion listings, to generate revenue. For the purposes of this specification, the definition of ‘advertisements’ do not include ‘paid search listings, including, but not limited to, paid placement listings or paid inclusion listings, as defined here.

Generally, paid placement listings, sometimes referred to as “cost-per-click”, are where merchants pay, bid, or a combination thereof as set by the search provider, for a high ranking or listing in the results of a search, when there is a “match” for a keyword on which the search is based that is somehow associated with the advertiser. Providers can also include other parameters to determine listings. Typically, a paid placement listings appear segregated from the results 134, such as in sidebar or column 202. Paid inclusion is when a website owner pays a fee in order to have his web pages included in the results 134, but usually with a higher ranking than it would otherwise have in the results 130. Those skilled in the art recognize that paid search listings can include other embodiments, such as, pay-per-click listings, and the like. Also, paid placement listings can include audio data, video data, or any combination of thereof.

The operation of the system 200 generally follows the same steps as outlined above for FIGS. 1-10. However, the search engine program 122 performs additional steps to accommodate the paid placement listings. Advertisers participate in a bidding process for search terms relevant to the advertisers website. The results of this bidding process is stored in an index on the database 126. Higher bids receive more advantageous placement in the results 134 or in column 202. When users submit queries into web page 132, the search engine program 122 generates results 134 from an index on the database 126. In addition, the search engine program determines the paid placement listings within the results 134 for within column 202.

Changes can be made in the above constructions without departing from the scope of the invention, it is intended that all matter contained in the above description or shown in the accompanying drawings shall be interpreted as illustrative and not in a limiting sense.

What is claimed is:

1. A method of administering a search engine through a computer system having at least one server, at least one client device, and a communication network operatively and electrically connecting the client device to the at least one server, the method comprising the steps of:
providing a primary search engine website running on the at least one server without transmitting advertisements to the at least one client device;
accessing, by a user from the client device, the primary search engine website, and entering search data into the at least one client device by the user, the user having previously agreed to access the primary search engine to perform a designated percentage of searches;
transmitting the search data to the at least one server;
generating, with a search engine program on the at least one server, search results associated with the search data and displaying the search results associated with the search data at the at least one client device;
tracking a percentage of searches performed by the user with the primary search engine; and
providing access to at least one service program to the user through an application program on the at least one server if the percentage of searches performed at least equals the designated percentage.

2. The method of claim 1, further comprising the step of:
generating, with a search engine program on the at least one server, paid search listings associated with the search data and displaying the search results associated with the search data at the at least one client device.

3. The method of claim 1, further comprising the steps of:
the user agreeing to recommend the primary search engine to additional users;
the additional users agreeing to access the primary search engine to perform a designated percentage of searches;
tracking the percentage of searches performed on the primary search engine by the additional users; and
providing access through the application program to an additional service program to the user for each designated number of additional users that agree to access the primary search engine to perform a designated percentage of searches.

4. The method of claim 1, further comprising the step of providing access through the application program to an additional service program to the user if the percentage of searches performed at least equals a higher designated percentage.

5. The method of claim 1, further comprising the step of providing access through the application program to an additional service program to the user if the percentage of searches performed is at least equals the designated percentage for a designated period of time.

6. The method of claim 1, wherein the at least one server comprises at least one host server having the application program providing access to the at least one service if the percentage of searches performed at least equals the designated percentage, the at least one host server having the at least one service program, and having a search engine program for generating the search results associated with the search data and displaying the search results associated with the search data at the at least one client device.

7. The method of claim 1, wherein the at least one server comprises:
at least one host server having the application program for providing access to the at least one service if the percentage of searches performed at least equals the designated percentage, the at least one host server having a search engine program for generating the search results associated with the search data and displaying the search results associated with the search data at the at least one client device; and
at least one merchant server having the at least one service program.

8. The method of claim 1, wherein the at least one server comprises:
at least one host server having the application program for providing access to the at least one service if the percentage of searches performed at least equals the designated percentage, the host server having the at least one service program; and
at least one search engine server having a search engine program for generating the search results associated with the search data and displaying the search results associated with the search data at the at least one client device.

9. The method of claim 1, further comprising the steps of:
transmitting a tracking program from the at least one server to the at least one client device;
tracking, by the tracking program, the percentage of searches performed on the primary search engine for a designated time period;
transmitting the percentage of searches performed to the at least one server;
storing the percentage of searches performed in the at least one server; and
comparing, by the application program, of the at least one server device the percentage of searches performed with the primary search engine to determine if the percentage of searches performed for the designated time period at least equals the designated percentage.

10. A method of administering a search engine through a computer system having at least one server, at least one client device, and a communication network operatively and electrically connecting the client device to the at least one server, the method comprising the steps of;
providing a primary search engine website running on the at least one server without transmitting advertisements to the at least one client device;
accessing, by a user from the client device, the primary search engine website, and entering search data into the at least one client device by the user, the user having previously agreed to access the primary search engine to perform at least a designated number of searches;
transmitting the search data to the at least one server;
generating, with the at least one server, search results associated with the search data and displaying the search results associated with the search data at the at least one client device;
tracking a number of searches performed by the user with the primary search engine with an application program; and
providing access to at least one service to the user through the application program if the number of searches performed at least equals the designated number.

11. The method of claim 10, further comprising the step of:
generating, with the at least one server, paid search listings associated with the search data and displaying the paid placement listings associated with the search data at the at least one client device.

12. The method of claim 10, wherein advertisements comprise audio data, video data, and any combination thereof.

13. The method of claim 10, further comprising the steps of:
the user agreeing to recommend the primary search engine to additional users;
the additional users agreeing to access the primary search engine to perform a designated number of searches;
tracking the number of searches performed on the primary search engine by the additional users; and
providing access through the application program to an additional service program to the user for each designated number of additional users that agree to access the primary search engine to perform a designated number of searches.

14. The method of claim 10, further comprising the step of providing access through the application program to an additional service program to the user if the number of searches performed at least equals a higher designated number.

15. The method of claim 10, further comprising the step of providing access through the application program to an additional service program to the user if the number of searches performed is at least equals the designated number for a designated period of time.

16. The method of claim 10, wherein the at least one server comprises at least one host server having the application program providing access to the at least one service if the number of searches performed at least equals the designated number, the at least one host server having the at least one service program, and having a search engine program for generating the search results associated with the search data and displaying the search results associated with the search data at the at least one client device.

17. The method of claim 10, wherein the at least one server comprises:
at least one host server having the application program for providing access to the at least one service if the number of searches performed at least equals the designated number, the at least one host server having a search engine program for generating the search results associated with the search data and displaying the search results associated with the search data at the at least one client device; and
at least one merchant server having the at least one service program.

18. The method of claim 10, wherein the at least one server comprises:
at least one host server having the application program for providing access to the at least one service if the number of searches performed at least equals the designated number, the host server having the at least one service program; and
at least one search engine server having a search engine program for generating the search results associated with the search data and displaying the search results associated with the search data at the at least one client device.

19. The method of claim 10, further comprising the steps of:
transmitting a tracking program from the at least one server to the at least one client device;
tracking, by the tracking program, the number of searches performed on the primary search engine for a designated time period;
transmitting the number of searches performed to the at least one server;
storing the number of searches performed in the at least one server; and
comparing, by the application program of the at least one server device, the number of searches performed with the primary search engine to determine if the number of searches performed for the designated time period at least equals the designated number.

20. A system connected by a communication network for administration of a search engine with a marketing component:
at least one client device connected to the communication network;
at least one server device electrically connected to the communications network so that tracking data can be sent from the at least one client device to the at least one server device, such tracking data including a percentage of searches performed on a primary search engine, wherein the at least one server device compares the tracking data with a designated percentage of searches to determine if the user is provided access to at least one service program, wherein the search engine program generates a paid placement listing without transmitting advertisements to the at least one client device.
